(19) United States
(12) Patent Application Publication
(10) Pub. No.: US 2008/0008558 A1
(43) Pub. Date: Jan. 10, 2008

(54) Fastening Arrangement and Method for Producing It

(75) Inventor: Sascha Costabel, Otisheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SFS INTEC HOLDING AG, Heerbrugg (DE)

(21) Appl. No.: 11/815,699

(22) PCT Filed: Jun. 9, 2006
(86) PCT No.: PCT/EP06/63036

§ 371 Date: Aug. 7, 2007

(30) Foreign Application Priority Data
Jun. 10, 2005 (DE) 102005026999.0

(51) Int. Cl. F16B 37/12

(52) U.S. Cl. 411/438

(57) ABSTRACT

Fastening arrangement for a lightweight structural component (1) is provided, including a housing (2) which is incorporated in the lightweight structural component (1), with the housing having a bore (3) with an internal thread (4), and a screw element (5). The housing (2) is formed in one piece. A threaded insert (6) formed as a helically wound spring is introduced into the bore (3) with a force fit and/or form fit, the internal boundary of which forms the internal thread (4) to allow the screw element (5) provided with an external thread (7) to be threadingly engaged.

### BACKGROUND

The present invention relates to a fastening arrangement for a structural element, in particular a lightweight structural element, with a housing that can be inserted into said structural element, having an internal thread and a screw element provided with an external thread, with the housing being embodied in one piece and with a threaded insert embodied as a helically wound wire being inserted into a bore of the housing with a force fit and/or a form fit, with its internal boundary forming the internal thread of the housing to screw in the threaded element.

Additionally, the invention relates to a method for producing such a fastening arrangement with the housing being inserted into the structural element, the threaded insert being inserted into the bore in the housing, and the screw element being inserted in the threaded insert.

A fastening arrangement of the type mentioned at the outset is known from GB 684 832. The known fastening arrangement serves to seal electric and other devices and to disclose any unauthorized opening of the device. In a sealed device, the threaded insert embodied as a helically wound wire is visibly anchored with one end in the bore of the device provided with a thread. When opening the device the anchored end of the threaded insert is visibly loosened from its engagement with the device and deformed. It is practically impossible to recreate the anchoring of the threaded insert in the device. The structural element at which the known fastening arrangement is mounted may be a part of the housing of the device, a bracket, or the like.

A fastening arrangement of the type mentioned at the outset is also known for various other special applications. In particular in aeronautics it is known that for mounting screw elements to a lightweight structural element, e.g., to a sandwich panel, said lightweight structural element is reinforced by the insertion of a housing. The housing typically produced from plastic is here produced via injection molding, having a metal part with a threaded bore, for which the metal part must be inserted through an expensive process into the injection mold.

Further, a threaded insert is known (DE 197 40 167 A1) that is screwed into a threaded bore of a work piece for reinforcement.

### SUMMARY

The object of the invention is to improve a fastening arrangement of the type mentioned at the outset such that when it is inserted into a lightweight structural element, the housing is produced without inserting a metal part with a threaded bore and which can be inserted into the lightweight structural element.

Additionally a method for producing such a fastening arrangement shall be provided.

This is achieved according to the invention in that another internal thread is formed in the wall of the bore, in which the threaded insert is incorporated, and/or by the threaded insert, upon being inserted into the bore of the housing, being incorporated in another internal thread formed in the wall of the bore. High extraction values in the connection of the housing and the threaded insert are particularly well achieved in the threaded insert having the same shape as the internal shape of the bore in the housing, which can be brought into a form-fitting contact with the housing as close as possible. By embodying the internal shape of the bore in the housing in form of another internal thread, the threaded insert can optimally be anchored in the housing and be fixed radially and axially. By screwing in the screw element, the threaded insert is additionally stressed in the housing and thus considerably increases the extraction values of the screw and the threaded insert from the housing. The shape of another internal thread can here be equivalent to any thread shape. By the one-piece embodiment of the housing, in particular made from a non-metallic material, weight and cost saving potentials are realized in the production of the housing. The production is particularly facilitated in that no additional part, such as e.g., a metallic threaded sheath or the like, needs to be inserted during injection molding in order to reinforce the thread. The fastening arrangement according to the invention is based on the screw element being mounted to a lightweight structural element in a simple manner with the help of two internally threaded parts. The structure of a lightweight structural element itself allows no direct connection to a screw element, because the structure is usually porous or has large hollow spaces. At the site of the fastening points, the lightweight structural element is provided with the housing of the fastening arrangement according to the invention, which is preferably made from a material with a low unit weight. In this manner, the requirements of minimum weight of the fastening arrangement are fulfilled to the extent possible. The object of the housing is to reinforce the lightweight structural element at the area where the fastening arrangement is to be mounted. By selecting the perimeter and the height of the housing, the fastening arrangement is designed in reference to the bore in the housing such that the extraction values between the lightweight structural element and the housing are of the same size as the ones between the housing and the threaded element.

Advantageous embodiments of the fastening arrangement according to the invention are the subject of the dependent claims.

In one embodiment the housing is provided with a lower strength than the threaded insert. The extraction values in the bore of the housing without any reinforcement are considerably lower when using material of the same strength values than between the lightweight structural element and the housing because the shearing area is correspondingly smaller. By using a threaded insert, the smaller area is compensated by the higher strength of the threaded insert. It is advantageous for the threaded insert to be anchored in the housing in a form-fitting manner. The threaded insert also contributes to higher extraction moments being achieved and thus the consequences of a potential shrinking of the housing, e.g., by aging or the like, can be compensated by a higher preliminary tension, which prevents any loosening of the threaded element.

In another embodiment, the housing is provided with a lower strength than the screw element. The screw element is designed such that the requirements to the fastening arrangement are fulfilled, but also result in a minimum weight. For this purpose, lightweight materials such as light metals, composite materials, or other plastics can be used for the screw element, which are characterized in high strength. By inserting a threaded insert into the housing, the connection between the screw element and the housing is reinforced such that the housing can be produced with a lower strength without becoming the critical element for the fastening arrangement with regard to material failure, e.g., by low extraction values or the like. In case of low requirements, the extraction values can at least be considerably enhanced by the features of the fastening arrangement according to the invention.

Further it is recommended that the housing is made from plastic. Plastics fulfill the features of a particularly low unit weight and thus can be used in a weight-saving manner. In spite of the low weight there is the chance to achieve good strength values, meeting the requirement of the fastening arrangement according to the invention. The housings can be produced in a more economical fashion by way of injection molding or the like and due to the simple production with higher process safety as well.

In particular polyetherimide (PEI), polyetheretherketone (PEEK), polyethersulphone (PES), GFK, carbon and fiberglass-reinforced plastic, composite material or the like are suggested for use. These materials are particularly suitable to produce components specifically adjusted to the application using conventional production methods. Plastics still show a wide range of potentially new combinations, in particular in combination with additional materials leading to a reinforcement and thus an improvement of the material features.

In another embodiment, the housing can be made from wood or the like. Instead of wood, the housing may also be made from another cellulose comprising man-made or natural product. Housings made from such porous materials are characterized in that the fastening arrangement can be connected to another structural element, such as the lightweight structural element, using an adhesive material, because the adhesive material diffuses into the porous structures of the housing and the lightweight structural element or penetrates it and hardens there. Furthermore, these materials are also particularly lightweight.

In another embodiment, the additional internal thread is simply formed by groove-shaped contours in the wall of the bore.

Another possibility comprises to provide the threaded insert with a self-cutting external thread for producing the other internal thread. This way, an additional simplification of the production and assembly process can be achieved, because during the injection molding of the housing, the interior shape of the bore can be produced without any grooves or threads and the threaded insert is designed such that it creates the additional internal thread automatically during the assembly in the housing. In addition to the simplified production process, an even better form fit can be achieved between the threaded insert and the housing.

Preferably the housing is inserted in a lightweight structural element made from Al-foam, light metals, or their alloys, GFK, sandwich panels, or the like. The use of the fastening arrangement according to the invention is particularly advantageous for the use in solutions designed to offer lightweight, highly stress-resistant fastening points. Particularly suitable for this purpose are lightweight structural elements, such as honey-comb shapes or the like made from materials, such as Al-foam, light metals, or their alloys or GFK or the like. Here, the honeycomb can be made from paper or the like, a curing foam, or any other material.

The fastening arrangement can be used particularly advantageous in aeronautics and aerospace technology. The search for increasingly lighter and more supportive materials is particularly influenced by the aeronautic and aerospace technology. The fastening arrangement according to the invention particularly targets high-value lightweight structural elements based on known and future materials.

Furthermore, the fastening arrangement is also particularly well suitable for the use in automobile construction, railway cars, or the like. By the increased use of lightweight construction materials in automotive technology, the fastening arrangement according to the invention provides the chance to economically and efficiently use fastening arrangements in lightweight structural parts, in particular in body construction. Presently used materials in prototype construction and small series, such as carbon, compound fibrous materials, such as GFK or the like will offer potential application fields for this fastening arrangement in the future, because the production costs can be lowered by the fastening arrangement according to the invention and the processing safety can be increased.

In one embodiment of the method for producing the fastening arrangement according to the invention, the housing is beneficially made in one piece, preferably by way of injection molding. In the subsequent preliminary assembly the insertion of the threaded insert occurs. In another step the preliminarily assembled housing is embedded in the lightweight structural element with epoxy resin or the like, and preferably adhered. Here, the zone around the housing is practically incompressible in the lightweight structural element, thus the extraction values of the housing made from the lightweight structural element increase and thus the fastening arrangement can be stressed more. The threaded bore created this way can now serve to allow screwing in a screw element, which is designed according to the specific requirements.

### BRIEF DESCRIPTION OF THE DRAWINGS

Exemplary embodiments of the invention are explained in greater detail in the following description using the drawings. They show:

FIG. 1 a fastening arrangement at a lightweight structural element;

FIG. 2 a housing, produced in one piece, for a fastening arrangement to a lightweight structural element;

FIG. 3 a housing produced in one piece with an installed threaded insert for a fastening arrangement to a lightweight structural element.

### DETAILED DESCRIPTION OF THE PREFERRED EMBODIMENTS

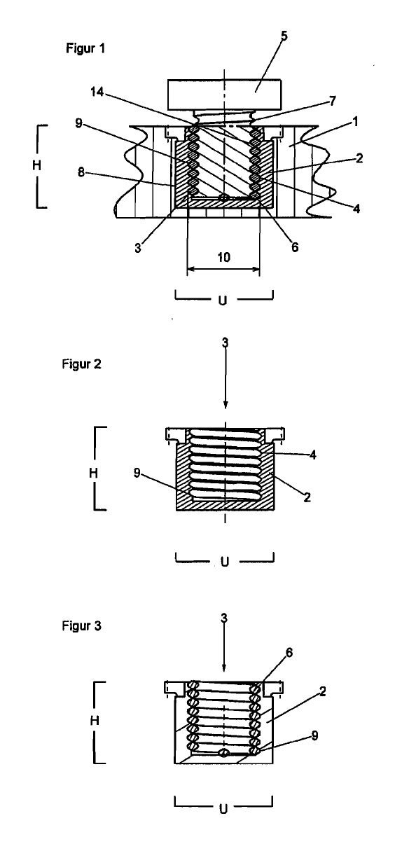

FIG. 1 shows a fastening arrangement at a lightweight structural element 1 comprising a housing 2 inserted into the lightweight structural element 1, with the housing having a bore or opening 3 with an internal thread 4, and a screw element 5. The housing element 2 is embodied in one piece. A threaded insert 6 formed as a helically wound wire is inserted into the internal thread 4 of the bore 3 in a form-fitting manner. The interior boundary of the threaded insert 6 forms an internal thread 14 for screwing in the screw element 5 provided with an external thread 7. The housing 2 can be produced in a particularly simple and economical fashion because it is made in one piece, i.e. without inserting another part, e.g., by way of injection molding. When sizing the housing 2, based on the simplification in the interior of the housing 2, the embodiment of the cylindrical exterior area can better be adjusted to. This contour can now be adjusted better to the features of the lightweight structural element 1. This leads to an even better connection between the lightweight structural element 1 and the housing 2. The housing 2 has a lower strength than the threaded insert 6. The threaded insert 6 must ensure the force transfer of the screw element 5 to the housing 2. In an advantageous embodiment, the strength features of the threaded insert 6 are therefore in the range of the screw element 5. An embodiment of the threaded insert 6 made from wire is particularly advantageous, said wire in turn being made from spring steel or the like. Through its resilience, the threaded insert 6 can ideally be adjusted to the internal thread 4 of the housing 2 and simultaneously enclose the screw element 5. The housing 2 has a lower strength than the screw element 5. In order to allow a fastening point to be mounted to a lightweight structural element 1, the lightweight structural element 1 is reinforced at this point by inserting the housing 2. Here, primarily an ideal force transfer is observed between the lightweight structural element 1 and the housing 2. For this purpose, the circumference U and the height H of the housing 2 are designed such that based on the size of the shearing area 10, stress levels can be reached which can be tolerated by the screw element 5, the threaded insert 5, and the internal thread 4 in the housing 2. For this purpose it is essential to allow the insertion of a housing 2 with a low weight, because otherwise the weight saving effect by the lightweight structural element 1 can be lost again. The strength of the housing 2 is correspondingly higher than that of the lightweight structural element 1. With the help of the threaded insert 6, the housing 2 is reinforced in the internal thread 4 such that the screw element 5 can be screwed into the internal thread 14, allowing larger and relatively heavy parts to be fastened to the lightweight structural element 1. For this purpose, the screw element 5 must be of such strength that it can also withstand, in addition to the stress by the weight to be fastened, any potential vibrations and other interactions. The housing 2 is inserted in a lightweight structural element 1 made from Al-foam, light metals, or their alloys, GFK, sandwich panels, or the like. In order to achieve lightweight structural elements 1 that are as weight-saving as possible, it is usually attempted to design these elements such that a honey-comb shaped, lightweight structure is located between two thin exterior layers, resulting in cooperation with the exterior layers to form a stiff unit. The honey-comb shaped structure is unsuitable for a fastening point, though. Therefore, a housing must be inserted at the fastening points allowing the installation of a fastening arrangement not being heavy in weight. A fastening arrangement according to the invention is particularly suitable for applications in aeronautics and aerospace technology as well as in automobile construction and in rail cars or the like. The attempts of aeronautics and aerospace technology to achieve increasingly higher payloads and consuming less energy lead to any weight optimization providing essential advantages in competition. While aeronautics and aerospace technology already examine all presently available weight optimizations and implement them if possible, a large potential in weight reduction remains in the fields of automobile construction, railway cars and the like, as also shown in the fastening arrangements according to the invention. A fastening arrangement with the features according to the invention can be produced in a particularly economical fashion by fastening the housing 2 to the lightweight structural element 1 and by inserting a threaded insert 6 into its bore 3, in which in turn a screw element 5 is fastened in a form-fitting manner. This simple method ensures that a fastening arrangement 1 can be mounted efficiently and quickly to the lightweight structural element 1, meeting even high requirements. By the simple production process the processing safety increases as well and thus also the overall quality of the fastening arrangement.

In a variant of the embodiment according to FIG. 2, the fastening arrangement in the lightweight structural element 1 is formed with a housing 2 made from plastic. The housing 2 is the central element for the fastening arrangement according to the invention. The housing 2 must be able to be integrated fixed in the lightweight structural element 1 and withstand the stress by the screw element 5. Plastics not only fulfill the requirements of a low weight of the housing 2, they can also be specifically and technically be adjusted to the respective task of the fastening arrangement. Used as the plastic are in particular polyetherimide (PEI), polyetheretherketone (PEEK), polyethersulphone (PES), GFK, carbon and fiberglass reinforced carbon, composite materials, or the like. It is suggested for particularly risky applications to use well-known proven material combinations because the material-specific features, such as flow characteristics, aging, weather resistance, etc. are essential for an optimal fastening arrangement. In alternative embodiment variants, the housing 2 may comprise wood or the like. The wooden structure can here be glued, compressed, or crude. Compacted embodiments are advantageous in that they react less sensitively to moisture-related changes and thus achieve a higher consistency of the fastening arrangement, however they are usually slightly heavier. The connection between the lightweight structural element 1 and the housing 2 can be optimally designed by an adhesive material 8, which enters the pores of the wooden structure but also the hollow spaces of the lightweight structural element 1 and cures. The bore 3 in the housing 2 has the internal thread 4 or groove-shaped contours 9. While the groove-shaped contours 9 are to be inserted as early as during the injection molding, the production of the internal thread 4 is also possible at a later time. The groove-shaped contours 9 can and should be adjusted as well as possible to the thread insert 6 to be inserted. Here, untypical contours can also be used for the threaded insert 6. The thread or groove contour used must be determined and sized based on the necessary technical features.

In another embodiment, FIG. 3 shows a fastening arrangement in a lightweight structural element 1, with its threaded insert 6 provided with a self-cutting external thread. In a particularly simple embodiment the housing 2 is provided with a bore 3, which has no threaded or grooved contour. In this way, it is also possible for the internal thread 4 to be cut or formed directly by the threaded insert 6 to be inserted. This way the threaded contour is produced in an even more form-fitting manner and an optimal connection is achieved.

1. A fastening arrangement for a structural element comprising a housing (2) that can be inserted into the structural element (1), provided with an internal thread (14) and a screw element (5) provided with an external thread (7), the housing (2) being formed in one piece and a threaded insert (6) comprising a helically wound wire inserted into a bore (3) in a force and/or form-fitting manner, with an internal boundary of the helically wound wire forming the internal thread (14) of the housing (2) for screwing in the screw element (5), and another internal thread (4) is formed in a wall of the bore (3), into which the threaded insert (6) is inserted.

2. A fastening arrangement according to claim 1, wherein the housing (2) has a lower strength than the threaded insert (6).

3. A fastening arrangement according to claim 1, wherein the housing (2) has a lower strength than the screw element (5).

4. A fastening arrangement according to claim 1, wherein the housing (2) is made from plastic.

5. A fastening arrangement according to claim 4, wherein the plastic comprises at least one of polyetherimide (PEI), polyetheretherketone (PEEK), polyethersulphone (PES), GFK, carbon and fiberglass-reinforced plastics, or composite-material.

6. A fastening arrangement according to claim 1, wherein the housing (2) is made from wood.

7. A fastening arrangement according to claim 1, wherein the additional internal thread (4) is formed by groove-shaped contours (9) in a wall (9) of the bore (3).

8. A fastening arrangement according to claim 1, wherein the threaded insert (6) is provided with a self-cutting external thread (7) for creating the other internal thread (4).

9. A fastening arrangement according to claim 1, wherein the housing (2) is inserted into a lightweight structural element (1) made from Al-foam, light metals, or their alloys, GFK, or a sandwich panels.

10. A fastening arrangement according to claim 9, wherein the structural element comprises an aerospace or aeronautical component.

11. A fastening arrangement according to claim 9, wherein the structural element is an automobile or railway component.

12. A method for producing a fastening arrangement comprising inserting a housing (2) in a structural element (1), installing a threaded insert (6) is in a bore (3) in the housing (2) by inserting the threaded insert (6) into another internal thread (4) formed in a wall of the bore (3) when it is inserted into the bore (3), and screwing a screw element (5) into the threaded insert (6).
